(19) United States
(12) Patent Application Publication
(10) Pub. No.: US 2006/0213572 A1
(43) Pub. Date: Sep. 28, 2006

(54) Multi-sectional conduit and a method of repairing existing conduits using said multi-sectional conduit

(76) Inventor: Andre Beaulieu, Saint-Marc-sur-Richelieu (CA)

Correspondence Address: KIRBY EADES GALE BAKER, BOX 3432, STATION D, OTTAWA, ON, K1P 6N9, CA

(21) Appl. No.: 11/373,914

(22) Filed: Mar. 14, 2006

Related U.S. Application Data
(60) Provisional application No. 60/662,350, filed on Mar. 17, 2005.

(51) Int. Cl. F16L 9/22

(52) U.S. Cl. 138/155; 138/162; 138/169; 138/97

(57) ABSTRACT

A length of conduit for encasing at least one electrical wire or cable, comprising two or more longitudinal conduit sections. Each longitudinal conduit section has two longitudinal edges formed with interlocking edge profiles shaped to engage with a snap fit with opposing longitudinal edge profiles of one or more other longitudinal conduit sections to form the conduit. Each conduit section also has one or more tabs or slots along the longitudinal edges to mate with tabs or slots on the other longitudinal conduit sections when brought together, to thereby substantially prevent relative longitudinal movement of the conduit sections. A longitudinal conduit section for use in forming the length of conduit is also described, which can be cut into two or more longitudinal conduit sub-sections and the sub-sections can be engaged to one another with a snap fit along the interlocking edge profiles to form a conduit. A damaged conduit repair kit, comprising two or more longitudinal conduit sections and two or more collar sections. A method of repairing a damaged conduit, is also described.

### CROSS REFERENCE TO RELATED APPLICATION

This application claims the benefit of U.S. Provisional Application No. 60/662,350 filed Mar. 17, 2005.

### FIELD OF THE INVENTION

The present invention relates to conduits for encasing and protecting wires and cables. The invention also relates to a method for repairing damaged electrical or telecommunications conduits.

### BACKGROUND OF THE INVENTION

Conduits made of resilient plastics and other materials are often used to encase and protect lengths of electrical and telecommunications wires and cables, as well as fibre optic cables. These conduits are commonly made of polyvinyl chloride (PVC) although other plastic and non-plastic materials may also be used.

The conduits carrying the cables can be laid both indoors and outdoors, above ground and underground to supply electricity, communications and other information to residential, commercial and industrial facilities. Building codes and national safety standards dictate that the cables and wires in the conduits be protected from water, air and mechanical strain therefore the conduits often provide an air-tight, water-tight encasement.

At times, due to exposure to weather elements and natural wear, the conduits can become damaged, thereby compromising the encasement of cables or wires therein. In repairing the damaged conduits, it is important that the necessary water and air tight seal be formed. This requires laboriously exact cutting of new conduit sections and cementing of these sections to the existing conduit and tends to be very costly. In particular, prior methods can involve displacing the wiring or cable from the damaged section of existing conduit, replacing the damaged existing conduit and then reinserting the displaced wiring. This method incurs a high cost since it is necessary to temporarily cut the electricity and/or communications in the affected area. To avoid shutting of power or communications lines unorthodox and inadequate methods are often resorted to in repairing the existing conduit.

One method of repair involves replacing the damaged portion of the existing conduit with new conduit. The new tube is either cut longitudinally into two sections by the worker or purchased as such. Once the proper length of conduit sections are cut, the two sections are then either adhered back together in situ with solvent cement of fastened to one another using known means such as strapping or taping. Concrete can optionally then be poured around the strapped or taped conduit and existing conduit to provide air and water tightness. The use of solvent cement in this method can be problematic since it is difficult to precisely align the conduit sections together in the few seconds before the solvent cement solidifies. The solvent cement acts to both adhere to the conduit sections and fuse the conduit sections and existing conduit together to form an integrated unit.

If the new conduit is misaligned as little as one tenth of a millimetre with the existing conduit, this can lead to air or water leaks. In such cases the conduit sections must be removed and are destroyed in the process due to their fusion with the existing conduit during cementing. These types of difficulties can lead to high repair costs.

Attempts have been made in the past to find means of maintaining the tube sections together while applying the solvent cement, or to use a split conduit that is cut only on one side. These attempts have been limited by the availability of industry-approved solvent cements and often do not meet industry approved standards. As well methods involving cutting the existing conduits act to reduce the circumference of the existing conduit, making retrofitting nearly impossible and leaving small gaps that allow water, particles and gas to infiltrate to the wiring contained inside.

There is therefore a need for a device and method of repairing damaged electrical and communications conduits in a way to maintain air-tight and water-tight integrity, and that requires as little cost and complex labour as possible.

### SUMMARY OF THE INVENTION

One aspect of the present invention provides a conduit for encasing at least one electrical wire or cable, comprising two or more longitudinal conduit sections. Each longitudinal conduit section has two longitudinal edges formed with interlocking edge profiles shaped to engage with a snap fit with opposing longitudinal edge profiles of one or more other longitudinal conduit sections to form the conduit. Each conduit section also has one or more tabs or slots projecting from or recessed into the longitudinal edges to mate with tabs or slots on the other longitudinal conduit sections when brought together, to thereby substantially prevent relative longitudinal movement of the conduit sections.

In a second aspect, the present invention provides a conduit unit comprising two or more conduits as described above, or the conduit described above and an existing conduit, connected together by one or more collars, wherein the collar comprises two or more longitudinal collar sections, each collar section having two longitudinal collar edges formed with interlocking collar edge profiles shaped to snap fit with opposing interlocking collar edge profiles of one or more other collar sections when the collar sections are brought together, and having one or more tabs and slots projecting from and recessed into the longitudinal collar edges to mate with tabs and slots on the other collar sections, to thereby substantially prevent relative longitudinal movement of the collar sections.

In a third aspect of the present invention, a longitudinal conduit section for use in forming the conduit is also described, comprising two longitudinal edges, each formed with an interlocking edge profile. The longitudinal conduit section can be cut into two or more longitudinal conduit sub-sections and the sub-sections can be engaged to one another with a snap fit along the interlocking edge profiles to form a conduit. The longitudinal edges of one conduit sub-section are shaped to mate with the longitudinal edges of other conduit sub-sections, to thereby substantially prevent relative longitudinal movement of the conduit sub-sections.

In a fourth aspect of the present invention, a longitudinal conduit section is provided for use in forming the conduit of the present invention, comprising two longitudinal edges formed with interlocking edge profiles shaped to engage with a snap fit with opposing longitudinal edge profiles of one or more other longitudinal conduit sections to form the conduit, wherein the longitudinal edges of the conduit section is shaped to mate with the longitudinal edge of one or more other conduit sections, when brought together, to thereby substantially prevent relative longitudinal movement of the conduit sections.

In a fifth aspect of the present invention a kit is provided for repairing or replacing conduit for encasing at least one electrical wire or cable, the kit comprising two or more longitudinal conduit sections that can be cut into sub-sections and two or more collar sections, each section comprising two longitudinal edges formed with interlocking edge profiles shaped to snap fit with opposing edge profiles of one or more other collar sections and one or more tabs and slots positioned along the longitudinal edges to mate with tabs and slots on the other collar sections when the sections are brought together, to thereby substantially prevent relative longitudinal movement of the collar sections.

In a sixth embodiment, a kit is also provided for repairing or replacing conduit for encasing at least one electrical wire or cable, the kit comprising two or more longitudinal conduit sections that are used without cutting and two or more collar sections, each section comprising two longitudinal edges formed with interlocking edge profiles shaped to snap fit with the interlocking edge profiles of one or more other collar sections and one or more tabs and slots positioned along the longitudinal edges to mate with tabs and slots on the other collar sections when the sections are brought together, to thereby substantially prevent relative longitudinal movement of the collar section

In a seventh embodiment the present invention provides a method of repairing a damaged conduit, comprising
cutting and removing a length of damaged conduit to expose cables held therein;
cutting two or more longitudinal conduit sections to a length substantially equal to the length of removed damaged conduit, wherein the conduit sections have longitudinal edges with interlocking edge profiles;
positioning the conduit sections around the exposed cables; and
snap fitting the interlocking edge profiles of the conduit sections together to form a length of conduit, having two ends, that covers the exposed cables.

In an eight embodiment of the present invention, a conduit for encasing at least one electrical wire or cable is provided, the conduit comprising two or more longitudinal conduit sections joined together along longitudinal edges thereof to form said conduit, each longitudinal edge including at least one tab or recess, each tab or recess mating with a tab or recess of an adjoining longitudinal edge of an adjacent conduit section, to thereby substantially prevent axial movement of said conduit sections relative to one another.

In a ninth embodiment of the present invention, a conduit for encasing at least one electrical wire or cable is provided, the conduit comprising two or more longitudinal conduit sections joined together along longitudinal edges thereof to form said conduit, wherein each longitudinal edge is shaped to mate with a longitudinal edge of an adjacent conduit section, to thereby substantially prevent axial movement of said conduit sections relative to one another.

### BRIEF DESCRIPTION OF THE DRAWINGS

The present invention will be described in conjunction with the following figures in which:

FIG. 1A is a perspective view of one embodiment of the conduit sections of the present invention, in an unassembled arrangement;

FIG. 1B is a perspective view of the conduit sections of FIG. 1A, in an assembled arrangement;

FIGS. 2A through 2D are detailed end views of different embodiments of the interlocking edge profile of the conduit sections or collar sections of the present invention;

FIG. 3 is a perspective view of one embodiment of the collar sections of the present invention, in an unassembled arrangement;

FIG. 4A is a cross-sectional elevation view of one embodiment of the conduit and collar of the present invention, in a fully assembled arrangement;

FIG. 4B is a perspective view of one embodiment of the conduit and collar of the present invention, in a fully assembled arrangement;

FIG. 4C is a perspective view of one embodiment of the conduit and collar sections of the present invention, showing the collars and conduit sections assembled, but not fitted together;

FIG. 4D is a perspective view of one embodiment of the conduit and collar sections of the present invention, in an unassembled arrangement;

FIGS. 5A through 5D are schematic diagrams showing one embodiment of a method of repairing a damaged conduit using the conduit sections and collar sections of the present invention;

FIG. 6 is a flowchart diagram illustrating the steps of one embodiment of the methods of the present invention; and

FIG. 7 is a detailed side elevation view of different embodiments of the shape of the longitudinal edge of the conduits sections and collar sections of the present invention.

### DEFINITIONS

Snap Fit—a fit in which the opposing interlocking edge profiles of the conduit or collar sections initially resist engaging one another when pushed together, until a point is reached when the resistance is overcome and the opposing interlocking edge profiles rapidly slide over one another and engage, after which the opposing edge profiles resist being separated.

Tab—any shape or size of projection from the longitudinal edge of the conduit section or collar section, which can be inserted into a slot. In connection with a slot, a tab may also include a longitudinal edge shape that mates with a similar longitudinal edge shape to substantially prevent longitudinal movement of the conduit sections or collar sections.

Slot—any shape or size of recess into the longitudinal edge of the conduit section or collar section, which can receive a tab. In connection with a tab, a slot may also include a longitudinal edge shape that mates with a similar longitudinal edge shape to substantially prevent longitudinal movement of the conduit sections or collar sections.

Resilient—a material that holds its shape and will not deform after removal of a load that has been placed thereon, when the load is less than the yield stress of the material. The term “resilient” is also used to encompass materials that can be manipulated to elastic deformation by hand.

Sections—individual and separate pieces of a conduit or collar that can be engaged to one another to form a conduit or collar.

Sub-section—individual and separate pieces of a conduit section or collar section.

Interlocking edge profile—a profile formed on the longitudinal edge of a conduit section or collar section, as seen in an end view, that can engage another interlocking edge profile with a snap fit. The interlocking edge profiles of each longitudinal edge of a conduit section or collar section may be the same or different.

### DETAILED DESCRIPTION OF THE PREFERRED EMBODIMENTS

The present invention provides a means of replacing damaged conduit in a cost and labour efficient manner. According to one aspect of the present invention, conduit sections are provided which can be joined together in a quick and precise manner to form conduit without having to rely on visual means to match the sections together and the sections do not slide transversely or fall out of place. The present invention can at least in preferred embodiments, create watertight and airtight conduit (especially, but not necessarily when used in combination with a solvent cement), to avoid water, particle or gas infiltration near electrical and communications wiring and cables.

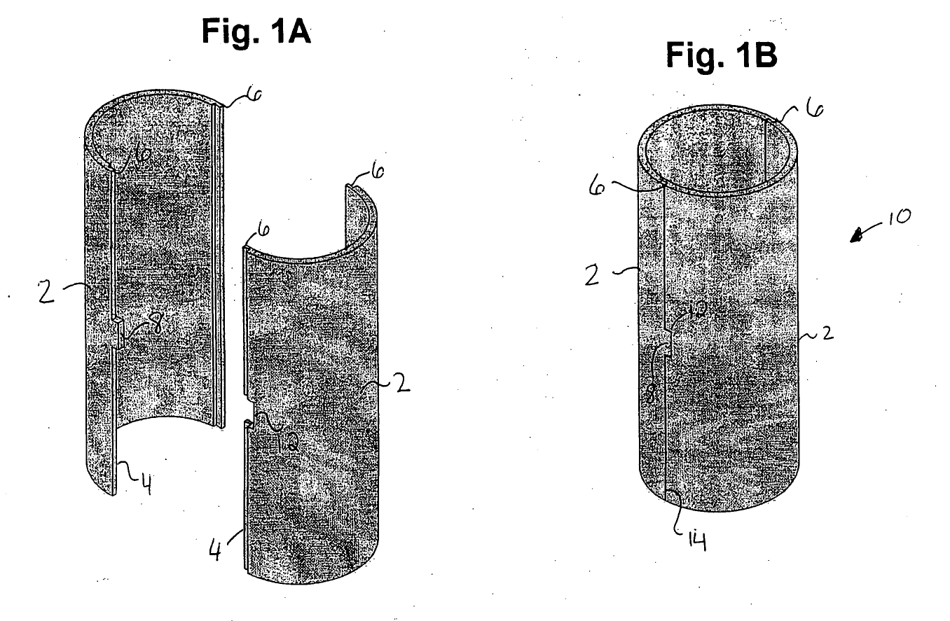

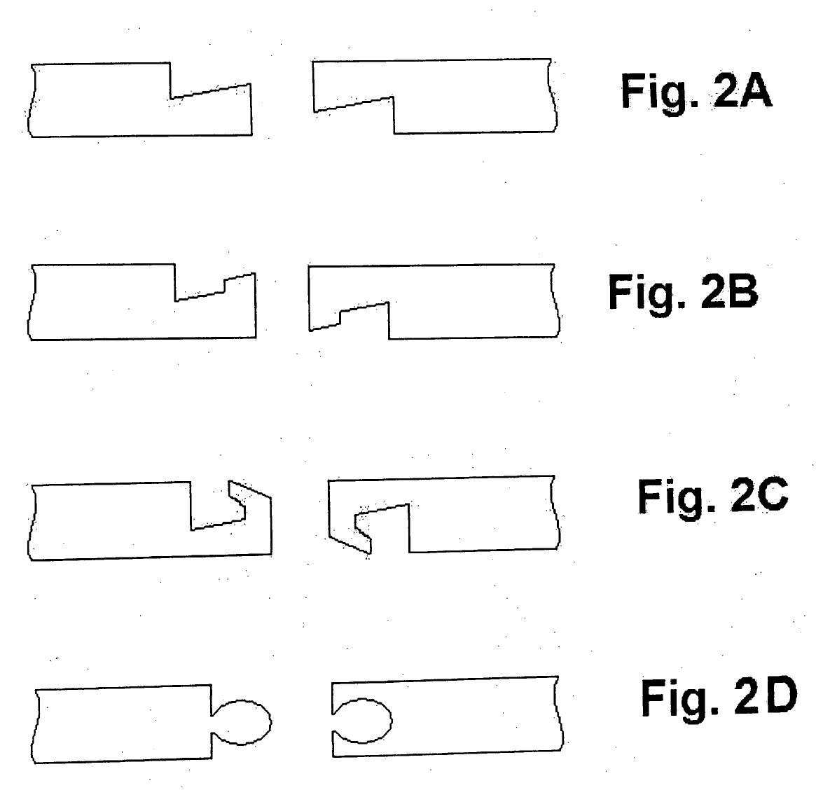

With reference to FIGS. 1A and 1B, one embodiment of the conduit 10 of the present invention comprises a pair of longitudinal conduit sections 2, each section 2 having two longitudinal edges 4, an inner surface, an outer surface and two ends. Each longitudinal edge 4 of each conduit section 2 has an interlocking edge profile 6 formed thereon that engages the interlocking edge profile 6 of another conduit section 2 in a snap fit when the sections 2 are pushed together. FIGS. 2A through 2D show various optional embodiments of the interlocking edge profile 6, wherein FIG. 2A shows an angle profile, FIG. 2B shows a wedge profile, FIG. 2C shows a hook profile and FIG. 2D shows a keyhole profile.

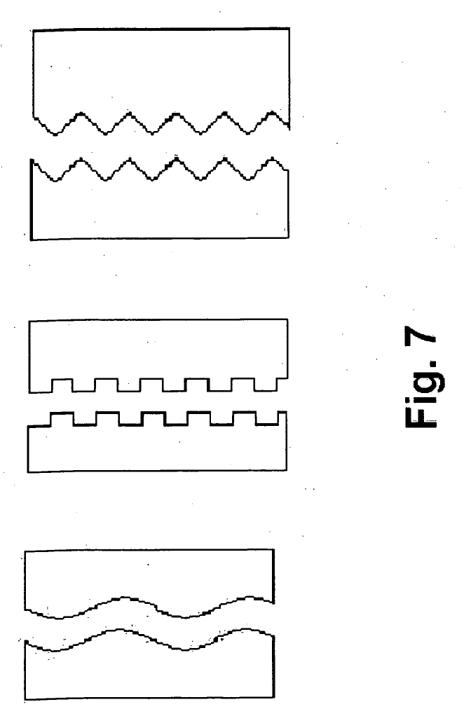

The conduit sections 2 of the present invention may also comprise means to hold the engaged conduit sections in a longitudinally fixed relation with one another, to prevent relative longitudinal movement between the conduit sections 2. One embodiment of this aspect of the invention is illustrated in FIGS. 1A and 1B, in which one or more projections in the form of tabs 8 are spaced along one or both longitudinal edges 4 of a conduit section 2. The tabs 8 fit into one or more corresponding slots 12 spaced along the mating longitudinal edges 4 of the other conduit section 2 to facilitate positioning. However it is also possible to have, for example, a wave formation, stepped formation or toothed formation along the longitudinal edge 4 of a conduit section 2, which can mate with a corresponding formation on an adjacent conduit section 2 to thereby prevent longitudinal movement between the sections. This is illustrated in FIG. 7.

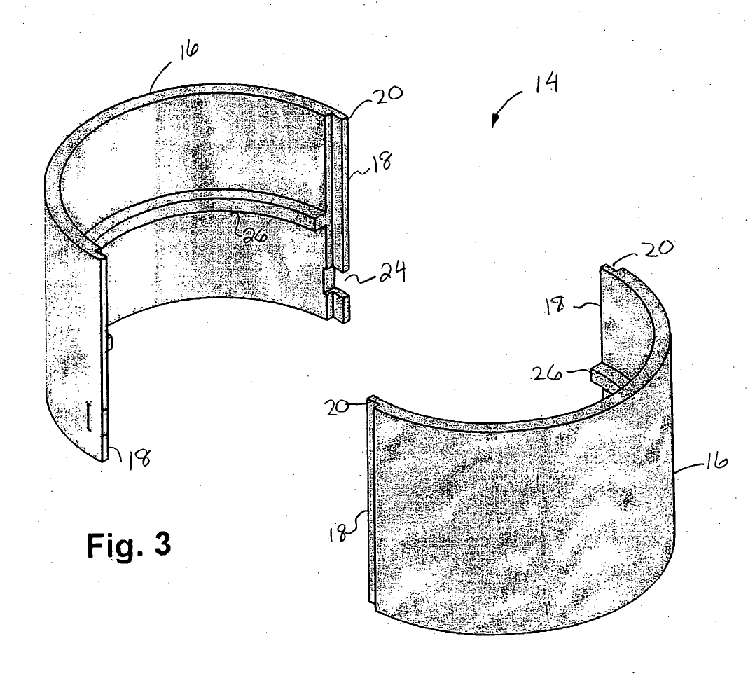

FIG. 3 illustrates one embodiment of a collar 14 for use in connection with the conduit 10 of the present invention. In this embodiment, the collar 14 consists of two collar sections 16. Similar to the conduit sections 2, each collar section 16 has two longitudinal edges 18. Each longitudinal edge 18 of each collar section 16 has an interlocking edge profile 20 formed thereon that engages with the longitudinal interlocking edge profile 20 of another collar section 16 to thereby ‘snap fit’ when placed together. FIGS. 2A through 2D show various optional embodiments of the interlocking edge profile 20 wherein FIG. 2A shows an angle profile, FIG. 2B shows a wedge profile, FIG. 2C shows a hook profile and FIG. 2D shows a keyhole profile.

As with the conduit sections 2, the collar sections 16 of the present invention also comprise means to hold the sections in a longitudinally fixed relation with one another, optionally in the form of one or more tabs 22 (not shown) and slots 24 spaced along the longitudinal edge 18 of the collar sections 16. As with the conduit sections, it is also possible to have, for example, a wave formation, stepped formation or toothed formation along the longitudinal edge 18 of a collar section 16, which can mate with a corresponding formation on an adjacent collar section 16, as illustrated in FIG. 7.

In a preferred embodiment, each collar section 16 optionally also has a stopper 26 to prevent the collar 14 from sliding down the length of the conduit 10, when applied thereon. In FIG. 3, this stopper 26 is illustrated as an annular ring encircling an inner circumference of the collar sections 16, however it is to be understood that other stoppers are also envisaged and included in the scope of the invention, such as for example, lugs or tabs spaced along the inner circumference of the collar sections 16.

Although the conduit sections 2 and collar sections 16 of the present invention have been illustrated as semi-cylindrical in shape, which snap together to form cylindrical conduit 10 or cylindrical collars 14, the conduit sections 2 and collar sections 16 may take other shapes and snap together to form conduit 10 or collars 14 of, for example, rectangular, square, oval or other cross-section. As well, although pairs of conduit sections 2 and collar sections 16 are shown in the drawings, it is also possible and within the scope of the invention to use more than two conduit sections 2 or collar sections 16, wherein the sections engage to form a conduit 10 or collar 14 of the desired cross-sectional profile. For example, a conduit section 2 or collar section 16 may make up one third of the circumference of a final cylindrical conduit 10 or collar 14, in which case three conduit sections 2 or collar sections 16 are snap fitted to one another to form the final conduit 10 or collar 14.

In a further optional embodiment, both tabs (8,22) and slots (12,24) of the conduit sections 2 and collar sections 16 may be present along the same longitudinal edge (4,18) to matingly engage slots (12,24) and tabs (8,22) on the longitudinal edge (4,18) of a corresponding conduit section 2 or collar section 16.

If the interlocking edge profile (6,20) of the conduit sections or collar sections are angled, as shown in FIG. 2A, then the angle of the interlocking edge profile (6,20) is preferably between 6 and 14°, and most preferably about 10°.

The snap fit caused by the mating interlocking edge profiles (6,20) of the conduit sections 2 and collar sections 16 acts to align and hold together the resultant conduit 10 and collar 14 during cementing, taping or other means of joining. The tab (8,22) and slot (12,24) features serve to align and prevent transverse motion of the conduit sections 2 or collar sections 16 relative to one another. The snap fit arrangement also means that the conduit sections 2 and collar sections 16 no longer have to be held in place while the solvent cement solidifies, if the sections are being cemented. The snap fit arrangement of the present invention also allows for conduit 10 and collars 14 to be assembled without any cementing. In such latter cases, concrete may be poured around the conduit 10 and collars 14 to improve air tightness and water-tightness.

The conduit sections 2 and collar sections 16 of the present invention can be made from a variety of resilient, metallic and non-metallic materials. Preferred materials are plastics such as, for example, PVC. Preferably, the materials should be resilient, corrosion-resistant, lightweight, and should provide a permanent watertight seal when adhered with a cement solvent. Lengths, widths and thickness of the conduit sections 2 and collar sections 16 as well as radius of curvature can vary based on particular applications.

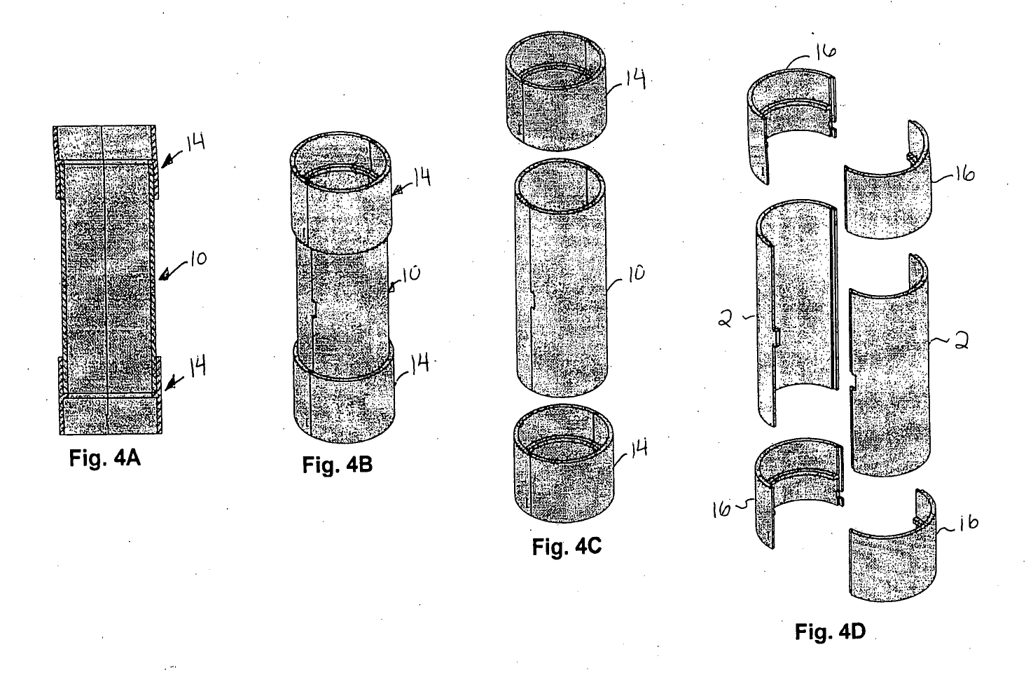

Assembly of a length of conduit 10 with associated collars 14 is illustrated in FIGS. 4A to 4D. To assemble a length of conduit 10 together with a pair of collars 14, the conduit sections 2 and collar sections 16 are first snap fitted together and optionally sealed using adhesives such as glue, cement, or solvent cements, if dictated by the applicable building standards. This is shown in FIGS. 4D and 4C. If solvent cement is used, this adhesive causes the conduit 10 to be watertight and airtight. The collars 14 are then fitted over each end of the newly formed conduit 10 and can optionally also be sealed to the conduit 10 using adhesives such as glue, cement, or solvent cement. This is illustrated in FIGS. 4B and 4A. The tab (8,22) and slot (12,24) features along the longitudinal edges (4,18) interact to facilitate positioning of the conduit 10 and collar 16.

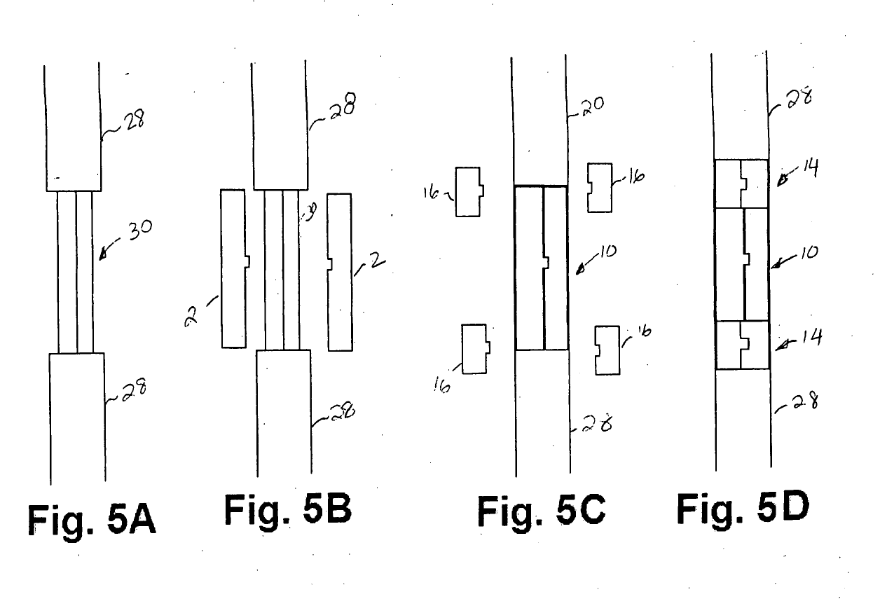

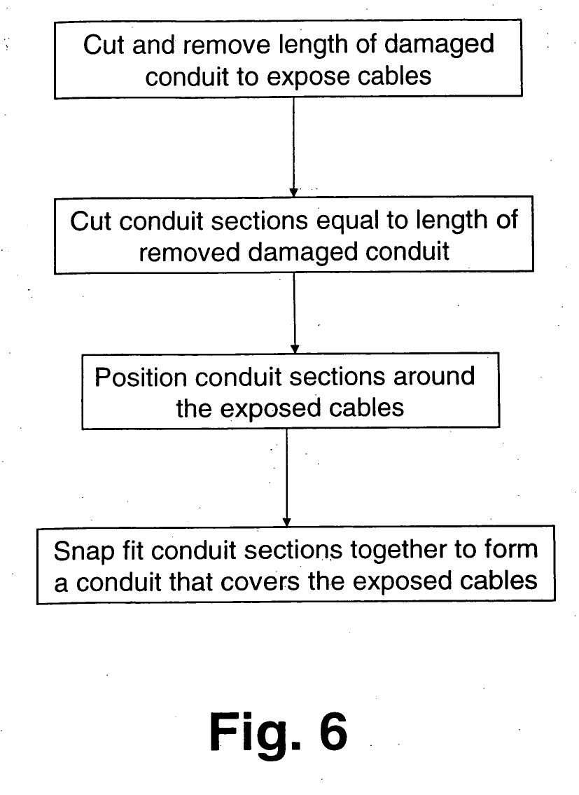

A preferred method of repairing damaged conduit is illustrated in FIGS. 5A to 5D. With reference to FIG. 5A, the damaged portion of the existing conduit 28 is first cut out and removed, exposing the cables 30 within the existing conduit 28. For the purposes of the present invention, the term cables 30 is understood to encompass electrical and telecommunications wires and cables, fibre optic cables and the like. The cut is preferably at a 90° angle and should form a straight edge along the circumference of the existing conduit 28. The conduit sections 2 are then cut to fit the space provide by the removed, damaged conduit, providing clearance for any optional couplings or adaptors that may need to be fitted over the existing conduit. Adhesives such as glue or solvent cement are then optionally applied to the longitudinal edges 4 of the conduit sections 2 and the conduit sections 2 are placed into position, using the tab 8 and slot 12 formations for alignment and to fix the conduit from any longitudinal movement. The sections 2 can then quickly be snap fitted together. Once the conduit 10 is snap fitted into place, the collars 14 can optionally be fitted over the conduit 10 and existing conduit 28. If required, solvent cement is first optionally applied to the longitudinal edges 18 and inside surface of the collar sections 16 as well as to the existing conduit 28 and new conduit 10, and the detachable collar sections 16 are placed over the junction between the conduit 28 and the new conduit 10. Similar to the conduit 10, the collar sections 16 are then lined up according the tab 22 and slot 24 formations and snap fitted into place to form collars 14.

In a further preferred embodiment, the invention embodies a single length of conduit section 2 having interlocking edge profiles 6 such as, for example the hook profile shown in FIG. 2C, or the keyhole profile of FIG. 2D. This single length can be cut into a desired number of sections of predetermined lengths and these sections can be snap fit to one another to form a resultant conduit 10.

In the optional embodiment of cementing the conduit 10 and collars 14, the snap action produced by the interlocking edge profiles (6,20) allow the sections to be fit together in a precise manner within the time required for the solvent cement to cure, which is typically about 5 to 30 seconds. The tabs (8,22) and slots (12,24) serve to prevent longitudinal slipping or misalignment. As well, the conduit sections 2 and collar sections 16 of the present invention do not move out of place while being cemented or otherwise joined, and there is less need to hold the sections (2,16) in place while the solvent cement solidifies. Since typical solvent cements serve both also partially dissolve the conduit 10 and collars 14 and adhere then to the existing conduit 28, the conduit 10 and collars 14 become integral to the existing conduit 28, allowing for air-tightness and water-tightness.

This detailed description of the methods and products is used to illustrate a preferred embodiment of the present invention. It will be obvious to those skilled in the art that various modifications can be made in the present device and that various alternative embodiments can be utilized. Therefore, it will be recognized that various modifications can be made in the products of the present invention and in the methods in which the products are applied without departing from the scope of the invention, which is limited only by the appended claims.

1. A conduit for encasing at least one electrical wire or cable, comprising two or more longitudinal conduit sections, each longitudinal conduit section having two longitudinal edges formed with interlocking edge profiles shaped to engage with a snap fit with opposing longitudinal edge profiles of one or more other longitudinal conduit sections to form the conduit, and having one or more tabs or slots projecting from or recessed into the longitudinal edges to mate with tabs or slots on the other longitudinal conduit sections when brought together, to thereby substantially prevent relative longitudinal movement of the conduit sections.

2. The conduit of claim 1 wherein the edge profile of the conduit section is selected from the group consisting of an angle profile, a wedge profile, a hook profile and a keyhole profile.

3. The conduit of claim 2 wherein the edge profile of the conduit section is an angle profile, having an angle of about 10°.

4. The conduit claim 1 wherein the conduit comprises two longitudinal conduit sections.

5. The conduit of claim 1 further comprising an adhesive applied along the longitudinal edges of each conduit section to fuse together the engaged conduit sections.

6. A conduit unit comprising two or more conduits as described in claim 1, or the conduit of claim 1 and an existing conduit, connected together by one or more collars, wherein the collar comprises two or more longitudinal collar sections, each collar section having two longitudinal collar edges formed with interlocking collar edge profiles shaped to snap fit with opposing interlocking collar edge profiles of one or more other collar sections when the collar sections are brought together, and having one or more tabs and slots projecting from and recessed into the longitudinal collar edges to mate with tabs and slots on the other collar sections, to thereby substantially prevent relative longitudinal movement of the collar sections.

7. A longitudinal conduit section for use in forming the conduit described in claim 1, comprising two longitudinal edges, each formed with an interlocking edge profile, wherein the longitudinal conduit section can be cut into two or more longitudinal conduit sub-sections and the sub-sections can be engaged to one another with a snap fit along the interlocking edge profiles to form a conduit and wherein the longitudinal edges of one conduit sub-section are shaped to mate with the longitudinal edges of other conduit sub-sections, to thereby substantially prevent relative longitudinal movement of the conduit sub-sections.

8. The longitudinal conduit section of claim 7 wherein the interlocking edge profile is a hooked profile or a keyhole profile.

9. The longitudinal conduit section of claim 7, further comprising an adhesive applied along the longitudinal edges of each conduit sub-section to partially dissolve and fuse together the engaged conduit sub-sections.

10. A longitudinal conduit section for use in forming the conduit described in claim 1, comprising two longitudinal edges formed with interlocking edge profiles shaped to engage with a snap fit with opposing longitudinal edge profiles of one or more other longitudinal conduit sections to form the conduit, wherein the longitudinal edges of the conduit section is shaped to mate with the longitudinal edge of one or more other conduit sections, when brought together, to thereby substantially prevent relative longitudinal movement of the conduit sections.

11. The longitudinal conduit section of claim 10, further comprising an adhesive applied along the longitudinal edges of each conduit sub-section to fuse together the engaged conduit sub-sections.

12. A kit for repairing or replacing conduit for encasing at least one electrical wire or cable, the kit comprising two or more longitudinal conduit sections as described in claim 7 and two or more collar sections, each section comprising two longitudinal edges formed with interlocking edge profiles shaped to snap fit with opposing edge profiles of one or more other collar sections and one or more tabs and slots positioned along the longitudinal edges to mate with tabs and slots on the other collar sections when the sections are brought together, to thereby substantially prevent relative longitudinal movement of the collar sections.

13. A kit for repairing or replacing conduit for encasing at least one electrical wire or cable, the kit comprising two or more longitudinal conduit sections as described in claim 10 and two or more collar sections, each section comprising two longitudinal edges formed with interlocking edge profiles shaped to snap fit with the interlocking edge profiles of one or more other collar sections and one or more tabs and slots positioned along the longitudinal edges to mate with tabs and slots on the other collar sections when the sections are brought together, to thereby substantially prevent relative longitudinal movement of the collar sections.

14. A method of repairing or replacing a damaged conduit for encasing at least one electrical wire or cable, the method comprising:
a. cutting and removing a length of damaged conduit to expose cables held therein;
b. providing two or more longitudinal conduit sections to a length substantially equal to the length of removed damaged conduit, wherein the longitudinal conduit sections have longitudinal edges with interlocking edge profiles;
c. positioning the longitudinal conduit sections around the exposed cables; and
d. engaging the interlocking edge profiles of the longitudinal conduit sections with a snap fit to form a length of conduit, having two ends, that covers the exposed cables.

15. The method of claim 14 further comprising applying adhesive to the longitudinal edges of the longitudinal conduit sections to fuse together the engaged longitudinal edges.

16. The method of claim 14 further comprising providing two or more collar sections having longitudinal collar edges with interlocking collar edge profiles, positioning the collar sections around a junction formed between the existing conduit and one end of the conduit and engaging the interlocking collar edge profiles with a snap fit to form a collar.

17. The method of claim 16 wherein the steps are repeated to form a collar around a junction between the existing conduit and the other end of the conduit.

18. The method of claim 16 further comprising applying adhesive to the longitudinal edges and an inner surface of the longitudinal collar sections to fuse together the engaged longitudinal edges and to fuse the inner surface of the collar sections to the conduit and existing conduit.

19. A conduit for encasing at least one electrical wire or cable, the conduit comprising two or more longitudinal conduit sections joined together along longitudinal edges thereof to form said conduit, each longitudinal edge including at least one tab or recess, each tab or recess mating with a tab or recess of an adjoining longitudinal edge of an adjacent conduit section, to thereby substantially prevent axial movement of said conduit sections relative to one another.

20. A conduit for encasing at least one electrical wire or cable, the conduit comprising two or more longitudinal conduit sections joined together along longitudinal edges thereof to form said conduit, wherein each longitudinal edge is shaped to mate with a longitudinal edge of an adjacent conduit section, to thereby substantially prevent axial movement of said conduit sections relative to one another.
